(19) United States
(12) Patent Application Publication
(10) Pub. No.: US 2007/0110632 A1
(43) Pub. Date: May 17, 2007

(54) Light measurement automated zeroing and referencing system

(75) Inventors: Theodore M. Garver, Edmonton (CA); Paul P. Pastushak, Edmonton (CA)

Correspondence Address: FREEDMAN & ASSOCIATES, 117 CENTREPOINTE DRIVE, SUITE 350, NEPEAN, ONTARIO, K2G 5X3, CA

(73) Assignee: Alberta Research Council Inc., Edmonton (CA)

(21) Appl. No.: 11/600,867

(22) Filed: Nov. 17, 2006

(30) Foreign Application Priority Data
Nov. 17, 2005 (CA) 2,527,287

(51) Int. Cl. B01L 11/00

(52) U.S. Cl. 422/101

(57) ABSTRACT

A water supply sub-system for connection to a water quality analyzer unit includes a water purification unit co-located with the water quality analyzer unit. Raw reference water is introduced into the water purification unit and passed along a flow path including at least a water purification element including a reverse osmosis unit. An automated reference water valve provides purified reference water to the water quality analyzer unit at predetermined time intervals for use in instrumental zeroing events. Low volume but high efficiency water purification elements are used advantageously to purify small volumes of water at regular intervals, thereby eliminating the need to maintain a reservoir of water for instrumental zeroing purposes.

### FIELD OF THE INVENTION

The instant invention relates generally to water quality analysis systems, and more particularly to a water supply sub-system for connection to an on-line, photometric water quality analyzer system.

### BACKGROUND

A process for treating water involves typically a number of inter-related steps that are performed according to a predetermined sequence. For instance, a drinking water treatment process includes a coagulation and/or flocculation step, one or more filtration steps, and a disinfection or sterilization step. The treatment process is designed to remove various types of biological and chemical pathogens that are suspended or dissolved in the water stream, and in some cases to improve the color, taste and odor of the treated water. Of course, quality control is very important when the water is intended for human consumption, and for this reason measurements are made routinely to determine treatment effectiveness. In fact, it is preferable to make several such measurements at various stages of the process, so as to identify problems as quickly as possible, and to adjust process parameters accordingly. Recently, factors including increased use of ultraviolet (UV) disinfection methods, legislated or mandated reporting of UV absorbance of drinking water, and efforts to reduce formation of THM (trihalomethanes) and other chlorinated organics have encouraged the use of UV-based or UV-visible-based water analyzers. Furthermore, UV-based or UV-visible-based water analyzers are suitable for use in environmental monitoring, industrial processes using water, wastewater treatment facilities, as well as in drinking water treatment facilities.

Light absorbance and light attenuation measurements typically are made with respect to a reference light intensity, and the quality of the reference light intensity measurement is critical to the accuracy of the light absorbance measurement. The general method of taking an absorbance measurement or a transmission measurement is used for spectral regions between UV and IR regions (180 nm-15 μm). This method normally involves taking a reference measurement of the sample matrix and then obtaining a second measurement with the sample matrix and the sample. Absorbance and transmission measurements with water as a matrix are normally in the spectral region between 200 nm and 2 microns (UV-visible-near IR). When measurements are made of low values of light absorbance, such as for instance after the final step in a drinking water treatment process, the accuracy to which the reference light intensity is known becomes particularly important. For instance, assuming measurement of a treated sample of drinking water, absorbance values obtained at 460 nm and at 254 nm typically are about 0.001 cm⁻¹ and 0.020 cm⁻¹, respectively. Assuming a 10 cm pathlength cell for the 460 nm measurement and a 4.5 cm pathlength cell for the 254 nm measurement, the absorbance readings are on the order of 0.01 cm⁻¹ for 460 nm and 0.1 cm⁻¹ for 254 nm. Therefore, typical values of light attenuation are 1% attenuation of light at 460 nm and 10% attenuation of light at 254 nm. This means that, for a measurement made at 460 nm, a 0.1% change of the light attenuation changes the reported value by 10%. Clearly, variation of the reference light intensity must be taken into account and corrected for when measurements are made of low values of light absorbance.

Several different factors are known to contribute to the variation of the reference light intensity, including: solarization, changes in lamp gas pressure due to lamp temperature, variation in lamp drive current stability, mercury vapour deposition, glass aging and solarization and flow-through measurement cell fouling. Using a dual beam system having a reference detector, which is used for measuring the intensity of light propagating along an optical path that does not include the sample being measured, corrects for the effects of some of the above-mentioned factors. However, periodic instrumental zeroing still is necessary to correct for variations that are due to slow processes, where the variation is generally systematic and small but measurable over the period between zeroing events. For instance, during critical measurement and control periods for drinking water treatment, contaminated runoff water increases measurement cell fouling rates thereby ruining measurements that are not routinely re-zeroed to eliminate measurement bias related to deposits on measurement cell windows.

Other solutions that have been put forward rely upon manual zeroing of the instrument, or automated zeroing using purified water that is stored in a reservoir. These systems have limitations related to either the frequency of zeroing or the length of time that they may operate without operator intervention. In particular, manual zeroing is performed by a human operator and is labour intensive. Accordingly, the human operator may perform the zeroing operation only infrequently, perhaps at the beginning of each work shift, on a daily basis, or even on a weekly basis. The absolute value of the reference light variation between manual zeroing events may be small, but for measurement of light absorbance at low absorbance values the resulting error still is very significant. Furthermore, manual zeroing is prone to human errors, is operator dependent, and may be forgotten or skipped for one reason or another.

Automated zeroing using purified water that is stored in a reservoir overcomes some of the problems that are inherent with a manual zeroing system. For instance, the zeroing event may be scheduled to occur automatically at predetermined intervals of time and the results are reproducible. Unfortunately, a separate reservoir of purified water must be maintained for use specifically during the automated zeroing operation. An operator must inspect the condition of the reservoir periodically to ensure an adequate supply for future zeroing operations, or the operator must at least respond to an automated alarm that is indicative of a low reservoir level. Of course, since the amount of water contained in the reservoir is finite, it is tempting to try to “conserve” water by one or both of spacing the zeroing events further apart in time and using a smaller amount of water for each zeroing event. Unfortunately, spacing the zeroing events further apart in time may result in larger uncorrected reference light source variations, whereas using a smaller amount of water for each zeroing event may not allow for adequate flushing of the sample water from the sample cell prior to zeroing. Both effects are detrimental to the accuracy of the light absorbance or light attenuation measurements.

Relying upon a reservoir of purified water has additional inherent disadvantages. Refilling of the reservoir must be scheduled in advance so that an adequate amount of purified water is obtained before the reservoir is completely emptied. Of even greater concern is the problem of assuring that the purified water is sufficiently pure for use in the zeroing operation. For instance, when the purified water is obtained from a third party it is possible for contamination to occur prior to delivery or during delivery. In addition, if the reservoir is compromised or contains a small amount of biological material when filled, then the condition of the water deteriorates further over time. This latter problem is especially significant if the system is designed to operate with the reservoir for extended periods of time without operator intervention, since the biological material may accumulate over time.

It would be advantageous to provide a light measurement zeroing and referencing system that overcomes at least some of the above-mentioned problems and limitations. In particular, it would be advantageous to provide a water supply sub-system for connection to an on-line, photometric water quality analyzer system.

### SUMMARY OF EMBODIMENTS OF THE INVENTION

It is an object of at least some of the embodiments of the instant invention to provide a water supply sub-system for connection to an on-line, photometric water quality analyzer system.

It is an object of at least some of the embodiments of the instant invention to provide a water supply sub-system for providing reference water for use in a zeroing operation of an on-line, photometric water quality analyzer system.

In accordance with an aspect of the instant invention there is provided a water supply sub-system for connection to a water quality analyzer unit, the water quality analyzer unit including a flow-through sample cell disposed along an optical path defined between a light source and a detector of the water quality analyzer unit, said water supply sub-system comprising: a water purification unit comprising an inlet for connection to a source of raw reference water and for providing a flow of raw reference water along a fluid flow path through the water purification unit, a water purification element disposed along the fluid flow path for receiving the flow of raw reference water and for removing a contaminant species therefrom so as to generate a flow of purified reference water, and an outlet for providing the flow of purified reference water from the water purification unit, the water purification element comprising a reverse osmosis unit; a reference water valve in fluid communication with the outlet and for being connected to the water quality analyzer unit, the reference water valve controllably switchable between an open position for providing the flow of purified reference water to the water quality analyzer unit during a first period of time and a closed position for preventing the flow of purified reference water to the water quality analyzer unit during a second period of time; and, a sample water valve in fluid communication with a sample water source and for being connected to the water quality analyzer unit, the sample water valve controllably switchable between an open position for providing a flow of sample water to the water quality analyzer unit during the second period of time and a closed position for preventing the flow of sample water to the water quality analyzer unit during the first period of time.

In accordance with another aspect of the instant invention there is provided a method for automatically zeroing a water quality analyzer system, comprising: producing an amount of purified reference water by providing water from a reference water source along a first water flow path through a water purification unit, the water purification unit co-located with the water quality analyzer system and comprising a reverse osmosis unit; during a first period of time, purging a flow-through sample cell of the water quality analyzer system with a first portion of the amount of purified reference water; during a second period of time, filling the flow-through sample cell with a second portion of the amount of purified reference water; obtaining a first measurement using the water quality analyzer system when the flow-through sample cell is filled with the second portion of the amount of purified reference water; and, using at least a value relating to the first measurement to correct a subsequent measurement obtained when sample water is provided to the flow-through sample cell via a second water flow path not including the water purification unit.

In accordance with yet another aspect of the instant invention there is provided a water quality analyzer system, comprising: a flow-through sample cell having a first inlet for receiving a flow of water, a containing portion for containing temporarily a known amount of the flow of water, and a first outlet; a light source for launching light at a wavelength within a predetermined region of the electromagnetic spectrum along an optical path through the flow-through sample cell; a light-detector disposed for receiving the light at a wavelength within a predetermined region of the electromagnetic spectrum after transmission through the flow-through sample cell; a water purification unit comprising a second inlet, a second outlet and a water purification element that is disposed along a water flow path between the second inlet and the second outlet, the second inlet for connection to a reference water source for providing a flow of water from the reference water source along the water flow path through the water purification element and out the second outlet, the water purification element comprising a reverse osmosis unit; an automated reference water valve in fluid communication with the second outlet, the reference water valve actuatable between an open position for providing a flow of purified water to the containing portion of the flow-through sample cell via the first inlet during a first period of time, and a closed position for preventing a flow of purified water to the containing portion of the flow-through sample cell during a second period of time; and, a sample water valve in fluid communication with a sample water source, the sample water valve controllably switchable between an open position for providing a flow of sample water to the containing portion of the flow-through sample cell via the first inlet during the second period of time and a closed position for preventing the flow of sample water to the containing portion of the flow-through sample cell during the first period of time.

### BRIEF DESCRIPTION OF THE DRAWINGS

Exemplary embodiments of the invention will now be described in conjunction with the following drawings, in which similar reference numbers designate similar items:

FIG. 1 is a simplified cross-sectional view of a modified dual-beam UV-visible absorbance measurement system;

FIG. 2 is a simplified block diagram of a water quality analyzer system including a water supply sub-system according to an embodiment of the instant invention;

FIG. 3 is a plot of UV absorbance values for different water samples;

FIG. 4a is a simplified block diagram of the water quality analyzer system of FIG. 2 in a normal operating mode;

FIG. 4b is a simplified block diagram of the water quality analyzer system of FIG. 2 during a zeroing/water purge cycle;

FIG. 4c is a simplified block diagram of the water quality analyzer system of FIG. 2 during an initial wash with detergent;

FIG. 4d is a simplified block diagram of the water quality analyzer system of FIG. 2 during a detergent recirculation-cleaning cycle;

FIG. 5 is a simplified timing diagram for different events for the water quality analyzer system of FIG. 2;

FIG. 6 is a plot of experimental data obtained during a zero event for 254 nm and 460 nm;

FIG. 7 is a plot of experimental data obtained during five days of light intensity measurements at 460 nm, showing the measurement for sample water at 460 nm (lower trace), the reference light intensity at 460 nm (upper trace) and the zero intensity at 460 nm (middle trace);

FIG. 8 shows a plot of normalized intensity values as measured separately along the reference optical path and along the sample optical path through the flow-through cell, and a plot of a ratio of the two normalized intensity values;

FIG. 9 is a plot of experimental data obtained during five days of light intensity measurements at 460 nm, showing a comparison of absorbance values obtained using corrections based upon the reference light intensity as measured along the reference optical path, and based upon the zero value as measured through the sample cell filled with purified reference water;

FIG. 10 is a difference plot obtained by dividing the absorbance value as corrected using the reference light intensity by the absorbance value as corrected using the zero value when purified reference water is present in the flow-through sample cell;

FIG. 11 shows a comparison of the absorbance values calculated according to equations 3 and 4 for a 24-hour period; and,

FIG. 12 is a simplified flow diagram of a method for automatically zeroing a water quality analyzer system, according to an embodiment of the instant invention.

### DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

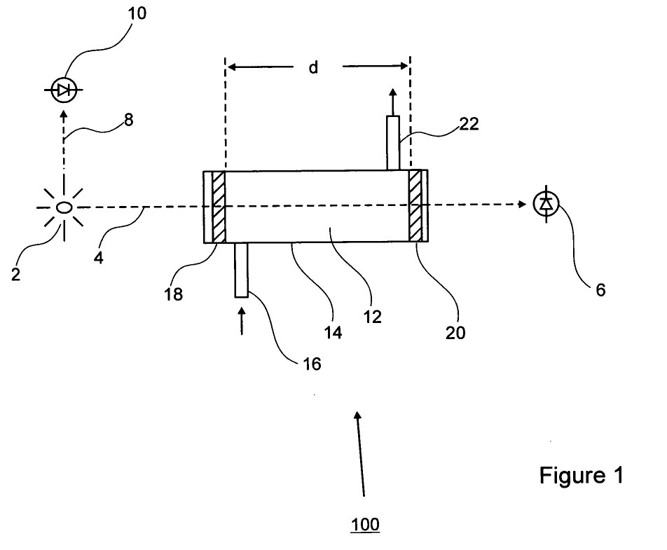

Referring to FIG. 1, shown is a simplified cross-sectional view of a modified dual-beam UV-visible absorbance measurement system, which is shown generally at 100. A light source 2 provides light along the measurement optical path 4 to a sample measurement detector 6, and also along a reference optical path 8 to a reference detector 10. A non-limiting example of a suitable light source is a deuterium lamp. Optionally, the light source 2 is temperature controlled in order to reduce variation of the source light intensity with time. Optionally, the light source current is controlled with a feedback control loop. Further optionally, the measurement optical path 4 includes other optical components, such as for instance not-illustrated collimating lenses.

The absorbance of light by a sample that is contained within a containing portion 12 of a sample flow-through cell 14 is ABS=−log(I/I₀), where I is the measured light intensity at the sample measurement detector 6 when the sample is in the flow-through cell 14, and I₀ is the light intensity at the sample measurement detector 6 when a clean reference (water) is in the flow-through cell 14. The sample and the clean reference are provided, during different periods of time, via an inlet 16 into the containing portion 12 between cell-windows 18 and 20 of the flow-through cell 14, and out through an outlet 22. The cell-windows 18 and 20 are fabricated from a material that is transmissive to light in the UV-visible region of the electromagnetic spectrum, such as for instance quartz. Of course, the cell-window material is selected in dependence upon the wavelength of light being measured, which wavelength is in one of the UV-visible-infrared regions of the electromagnetic spectrum. A distance between facing surfaces of the cell-windows 18 and 20 defines the cell pathlength, d, which is the distance light travels through the sample or clean reference. Cell pathlength values range from less than 1 mm to several meters, but more typical values are between 4.5 cm and 20 cm, by way of non-limiting example. Of course, the cell pathlength is selected for a particular application based upon a plurality of factors including the wavelength of the light being measured, the approximate concentration of absorbing species in the sample, and even the quality of the optical components in the system.

Variation of the illumination intensity from the light source 2 is corrected for by using measurement intensities that are relative to an independently measured light intensity, as measured by the reference detector 10 in FIG. 1. Accordingly, the system shown at FIG. 1 is referred to as a ratiometric detection system, because arbitrary intensity values are given as a ratio of the intensity at the sample measurement detector 6 to the reference detector 10. Hence, the absorbance (in arbitrary units) is:

$$ABS = [ - log ( \frac{( \frac{{I}_{m , t}}{{I}_{r , t}} )}{( \frac{{I}_{m , 0}}{{I}_{r , 0}} )} ) ] = [ - log ( ( \frac{{I}_{m , t}}{{I}_{r , t}} ) * ( \frac{{I}_{r , 0}}{{I}_{m , 0}} ) ) ] \qquad ( 1 )$$

where I_{m,t} is the intensity at sample measurement detector 6 at arbitrary time=t, I_{r,t} is the intensity at reference detector 10 at arbitrary time=t, I_{r,0} is the intensity at reference detector 10 during a zero event, and I_{m,0} is the intensity at sample measurement detector 6 during a zero event.

If the primary cause of variation in the illumination through the sample is related to the illumination source 2, then optionally an instrumental zeroing event is done only infrequently, such as for instance during the initial instrumental start-up, and the reference detector measurement is used to stabilize the measurement as described above. Under these conditions, and taking the cell pathlength into consideration, the absorbance is given by:

$$ABS = [ \frac{1}{d} ] * [ - log ( \frac{{I}_{m , t}}{{I}_{m , 0 first} * ( \frac{{I}_{r , t}}{{I}_{r , 0 first}} )} ) ] \qquad ( 2 )$$

where d is the cell pathlength in centimeters, I_{m,t} is the intensity at sample measurement detector 6 at arbitrary time=t, I_{m,0 first} is the intensity at sample measurement detector 6 during an initial zero period when the flow-through cell 14 is filled with purified reference water, I_{r,t} is the intensity at reference detector 10 at arbitrary time=t, and I_{r,0 first} is the intensity at reference detector 10 during the initial zero period when the flow-through cell 14 is filled with purified water. It is worth noting that the intensity at the reference detector 10 is independent of the contents of the flow-through cell 14, since the reference optical path 8 between the light source 2 and the reference detector 10 does not include the flow-through cell 14.

However, if there are variations along the measurement optical path 4 that influence the transmission of light through the flow-through cell 14, and that are independent of the measured sample, then the instrumental zeroing event becomes more important to the accuracy of the measurement. This is especially true when the source of the variation is fouling of the cell-windows 18 and 20, as this greatly diminishes the light intensity through the flow-through cell 14 independently from the measurement. During an instrumental zeroing event in a water analysis application, clean reference water is introduced into the containing portion 12 of the flow-through cell 14 via inlet 16, and out through outlet 22. Preferably, the clean reference water is flowed through the flow-through cell 14 for a period of time that is sufficient to flush all of the sample water from the containing portion. The clean reference water continues to flow through the flow-through cell 14 during the measurement, and then the flow of the clean reference water is stopped and the sample water is diverted through the flow-through cell 14. Depending upon the size of the containing portion 12 and the length of time the clean reference water flushes through the containing portion 12, between 200 ml and 500 ml of clean reference water is used per instrumental zeroing event. Of course, the actual amount of clean reference water required per instrumental zeroing event depends upon the actual system design, and the range of between 200 ml and 500 ml as specified above is given by way of non-limiting example only. For multiple zeroing events, the absorbance is given by:

$$ABS = [ \frac{1}{d} ] * [ - log ( \frac{{I}_{m , t}}{{I}_{m , 0 last}} ) ] \qquad ( 3 )$$

where d is the cell pathlength in centimeters, I_{m,t} is the intensity at sample measurement detector 6 at arbitrary time=t, and I_{m,0 last} is the intensity at the sample measurement detector 6 during the last zero period when the flow cell is filled with purified reference water. The value of I_{m,0 last} is updated every time an instrumental zeroing event is performed.

If multiple zeroing events are used with correction for variation of light intensity between the zeroing events, then equation 3 may be rewritten as follows:

$$ABS = [ \frac{1}{d} ] * [ - log ( \frac{{I}_{m , t}}{{I}_{m , 0 last} * ( \frac{{I}_{r , t}}{{I}_{r , 0 last}} )} ) ] \qquad ( 4 )$$

where d is the cell pathlength in centimeters, I_{m,t} is the intensity at sample measurement detector 6 at arbitrary time=t, I_{m,0 last} is the intensity at the sample measurement detector 6 during the last zero period when the flow cell is filled with purified reference water, I_{r,t} is the intensity at reference detector 10 at arbitrary time=t, and I_{m,0 last} is the intensity at the reference detector 10 during the last zero period when the flow cell is filled with purified reference water. Equation 4 provides a very accurate measurement as long as the time between zeroing events is set so that the attenuation due to fouling that occurs between zeroing events is small compared to the attenuation due to the measured sample.

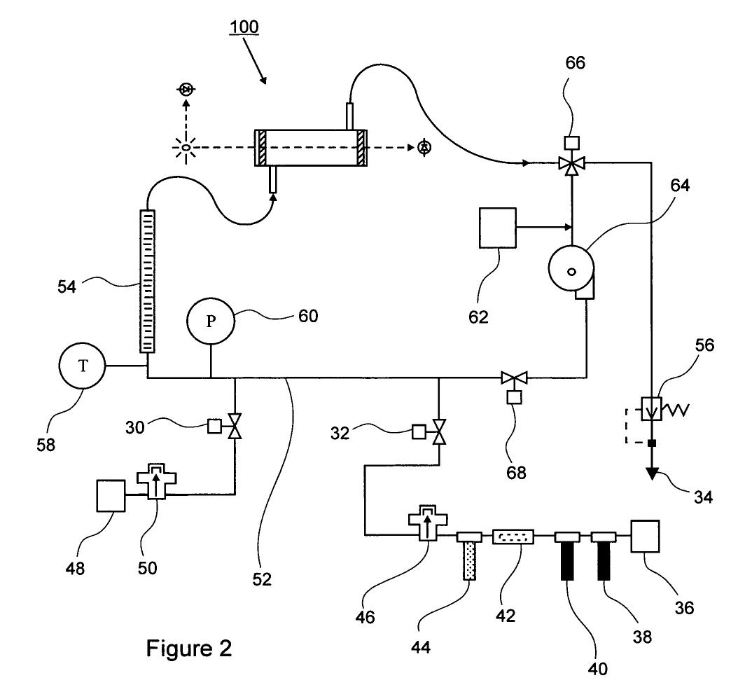

Referring now to FIG. 2, shown is a simplified block diagram of a light-based water quality analyzer system including a water supply sub-system according to an embodiment of the instant invention. The modified dual-beam UV-visible absorbance measurement system 100 is provided in fluid communication with the water supply sub-system via a sample water valve 30 and a reference water valve 32. By way of non-limiting example, each one of the sample water valve 30 and the reference water valve 32 is an automated solenoid valve. The sample water valve 30 and the reference water valve 32 manage the flow of sample water and reference water through the flow-through cell 14 and into a drain 34. For instance, a not illustrated controller provides control signals for controllably switching the automated reference water valve and the automated sample water valve in a synchronized fashion, so as to manage the flow of sample water and reference water.

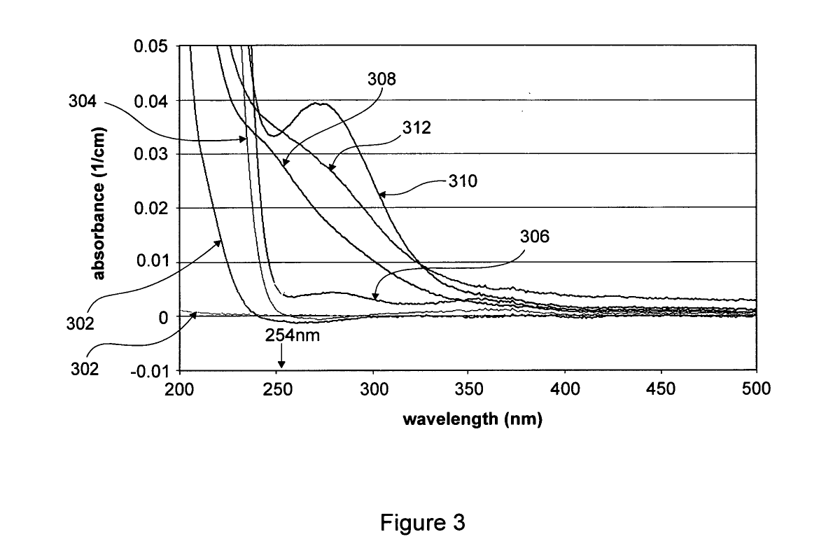

Referring still to FIG. 2, a plurality of water purification elements are disposed between the reference water valve 32 and a reference water source 36. One non-limiting example of a reference water source 36 is a drinking water tap. The plurality of water purification elements includes a reverse osmosis unit. Additionally, the plurality of water purification elements preferably includes both filtration-type elements and adsorption-type elements. Of course, some of the purification elements may be classified as both a filtration-type element and as an adsorption-type element. By way of one specific and non-limiting example, reference water from the reference water source is passed through a first activated carbon block filter 38, a second activated carbon block filter 40, a reverse osmosis unit 42, an activated carbon granular filter 44 and a bubble trap 46. Optionally, purified reference water after passing through the plurality of water purification elements is accumulated in a reservoir, the reservoir dimensioned for containing a sufficient amount of purified reference water to perform a single instrumental zeroing event. Alternatively, the flow rate of reference water through the plurality of water purification elements is sufficiently high to supply purified reference water directly during the instrumental zeroing event. Optionally, sample water is provided from a sample water source 48 through a bubble trap 50 prior to being introduced into the flow-through cell 14 via the sample water valve 30. For reasons that are discussed below with reference to FIG. 3, the reverse osmosis unit 42 is necessarily included in the plurality of water purification units.

As shown in FIG. 2, the sample water valve 30 and the reference water valve 32 are both in fluid communication with the modified dual-beam UV-visible absorbance measurement system 100 via a conduit 52. Disposed along the conduit between the valves 30, 32 and the modified dual-beam UV-visible absorbance measurement system 100 is a flow meter 54. A pressure regulator 56 is disposed before the drain 34, for controlling pressure within the system. Optionally, a temperature sensor 58 and/or a pressure sensor 60 are disposed at points along the conduit 52 between the valves 30, 32 and the modified dual-beam UV-visible absorbance measurement system 100. Further optionally, a cleaning system is also provided. By way of a non-limiting example, the cleaning system includes a detergent source 62, a pump 64, and first and second control valves 66, 68. Advantageously, the cleaning system removes deposits that otherwise foul the cell-windows 18 and 20 under normal operating conditions.

Referring now to FIG. 3, shown are plots of UV absorbance values for different water samples, and a baseline plot. The reference water that is used in the above-mentioned instrumental zeroing events preferably does not absorb light at wavelengths within the range of wavelengths that are being measured. In other words, preferably the purified reference water has an absorbance of near zero at the measurement wavelengths. Referring still to FIG. 3: plot 300 is a baseline plot; plot 302 is data for water after passage through a series arrangement of a carbon block filter, a reverse osmosis unit, and a granulated activated carbon filter; plot 304 is data for water after passage through a series arrangement of a carbon block filter and a reverse osmosis unit; plot 306 is data for water after passage through a carbon block filter; plot 308 is data for water obtained directly from a drinking water tap; plot 310 is data for water that was obtained directly from a laboratory water tap; and, plot 310 is data for water that was obtained directly from a laboratory hot water tap. As shown in FIG. 3, the absorbance of the tap water is about 0.03 cm⁻¹ at 254 nm. This means that a background absorbance of 0.003 cm⁻¹ leads to a 10% error in the true reading for tap water.

Referring still to FIG. 3, it was determined experimentally that water that is passed only through a carbon block filter (see plot 306) has an absorbance of 0.003 cm⁻¹. Based upon the realization that a background absorbance of 0.003 cm⁻¹ leads to a 10% error in the absorbance values that are typical of drinking water, additional experimentation was undertaken in order to determine an arrangement of water purification elements suitable for use with embodiments of the instant invention. The water that has been through a carbon block filter then a reverse osmosis filter and then a granulated activated carbon filter (see plot 304) has substantially zero absorbance at 254 nm. It was thus determined that inclusion of a reverse osmosis unit in the plurality of water purification elements beneficially removes contaminants, thereby providing a source of reference water that has 100.00% transmittance and zero absorbance. Utilizing such ultra-pure reference water during the instrumental zeroing events is critically important in order to obtain sample water absorbance values with improved accuracy under the very low absorbance conditions that are typical in drinking water treatment applications.

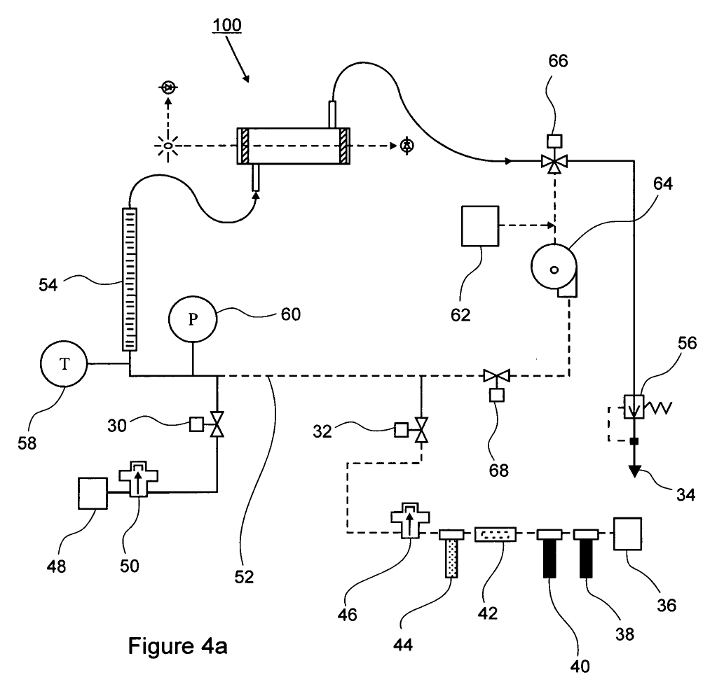

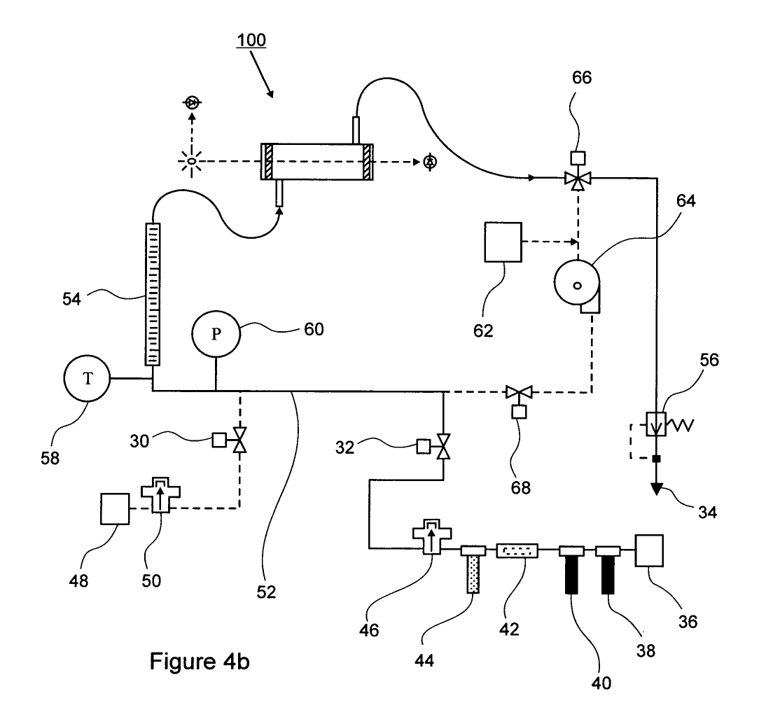

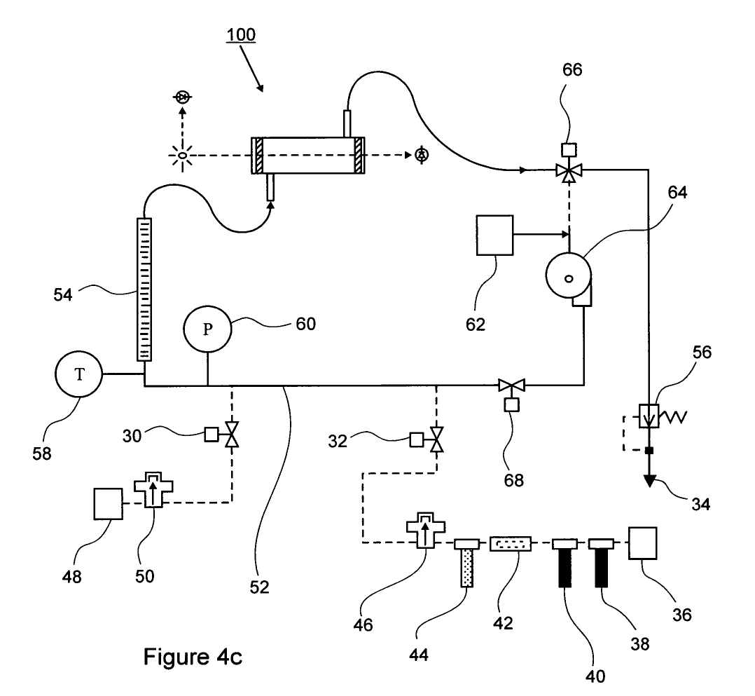

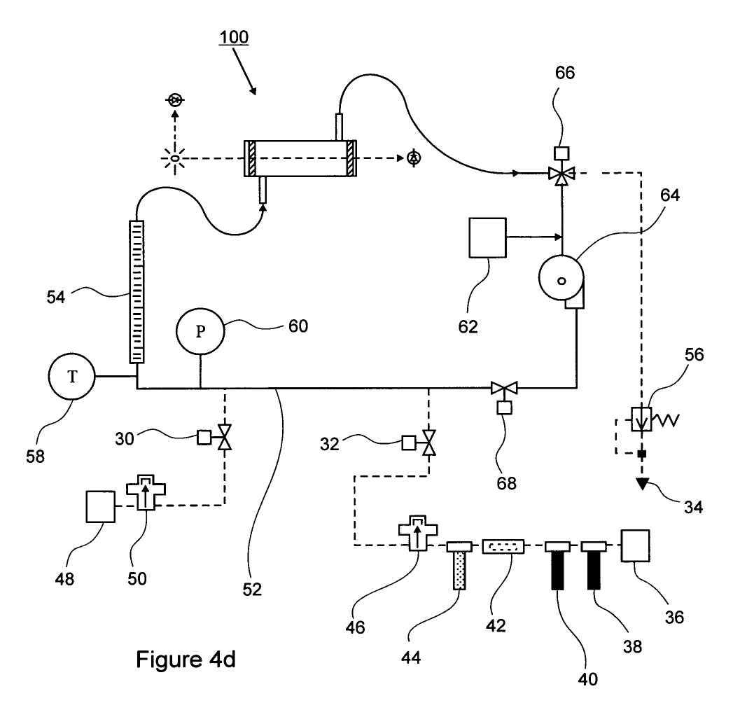

Referring now to FIG. 4a, shown is a simplified block diagram of the water quality analyzer system of FIG. 2 in a normal operating mode. In the normal operating mode, the sample water flows from the sample water source 48 through an optional bubble trap 50 to the sample water valve 30, which is in the open position during normal operation. The sample water continues along the conduit 52, through flow meter 54, and into the modified dual-beam UV-visible absorbance measurement system 100. The sample water then flows through the first control valve 66 to pressure regulator 56 and out of the system via drain 34. During a period of time in which the sample water is flowing through the modified dual-beam UV-visible absorbance measurement system 100, a measurement is made of the light absorbance or light attenuation by the sample. The measurement is made using light within a predetermined range of wavelengths. Optionally, the measurement is made at a “single wavelength” or at a plurality of “single wavelengths”, wherein the term “single wavelength” is defined to mean that approximately monochromatic light is used to irradiate the sample, and wherein the approximately monochromatic light is defined as light within a wavelength range having a width of approximately 1 nm. Alternatively, the measurement is made by scanning continuously between a lower wavelength limit and an upper wavelength limit. Optionally, a light dispersive element is placed along the light path between the lamp and one or more detectors so that the light intensity is obtained at a plurality of wavelengths.

Referring now to FIG. 4b, shown is a simplified block diagram of the water quality analyzer system of FIG. 2 during a zeroing/water purge cycle. In FIG. 4b, the sample water valve 30 is in the closed position to stop the flow of water from the sample water source 48 to the conduit 52. The reference water valve 32 is now in the open position so that reference water flows from the reference water source 36 through the plurality of water purification elements 38, 40, 42, 44 and bubble trap 46 to the conduit 52. The sample water continues along the conduit 52, through flow meter 54, and into the modified dual-beam UV-visible absorbance measurement system 100. The sample water then flows through the first control valve 66 to pressure regulator 56 and out of the system via drain 34. During a period of time in which the purified reference water is flowing through the modified dual-beam UV-visible absorbance measurement system 100, a measurement is made of the light absorbance or light attenuation by the purified reference water. A value relating to the measurement is stored in a memory element and/or used for zeroing the instrument.

Referring now to FIG. 4c, shown is a simplified block diagram of the water quality analyzer system of FIG. 2 during an initial wash with detergent. In FIG. 4c, both the sample water valve 30 and the reference water valve 32 are closed. Detergent is provided from the detergent source 62 and pumped by pump 64 through the conduit 52, past the second control valve 68 to flow meter 54, and into the modified dual-beam UV-visible absorbance measurement system 100. The detergent then flows through the first control valve 66 to pressure regulator 56 and out of the system via drain 34. During the initial wash with detergent, any remaining sample water or purified reference water is flushed from the measurement side of the system with respect to valves 30 and 32. As shown in FIG. 4c, the detergent does not flow past the sample water valve 30 or the reference water valve 32.

Referring now to FIG. 4d, shown is a simplified block diagram of the water quality analyzer system of FIG. 2 during a detergent recirculation-cleaning cycle. The detergent recirculation-cleaning cycle follows the initial wash with detergent. During the detergent recirculation-cleaning cycle, the first control valve 66 is switched to a position for diverting the detergent away from the drain 34 and along a path toward the pump 64. The same detergent solution is pumped continuously through the system until the end of the detergent recirculation-cleaning cycle, and additional detergent is not added from the detergent source 62. At the end of the detergent recirculation-cleaning cycle, one of the sample water valve 30 and the reference water valve 32 is opened, and the system is purged of detergent by closing the second control valve 68 and switching the first control valve to a position for diverting the detergent away from the pump 64 and along a path toward the drain 34.

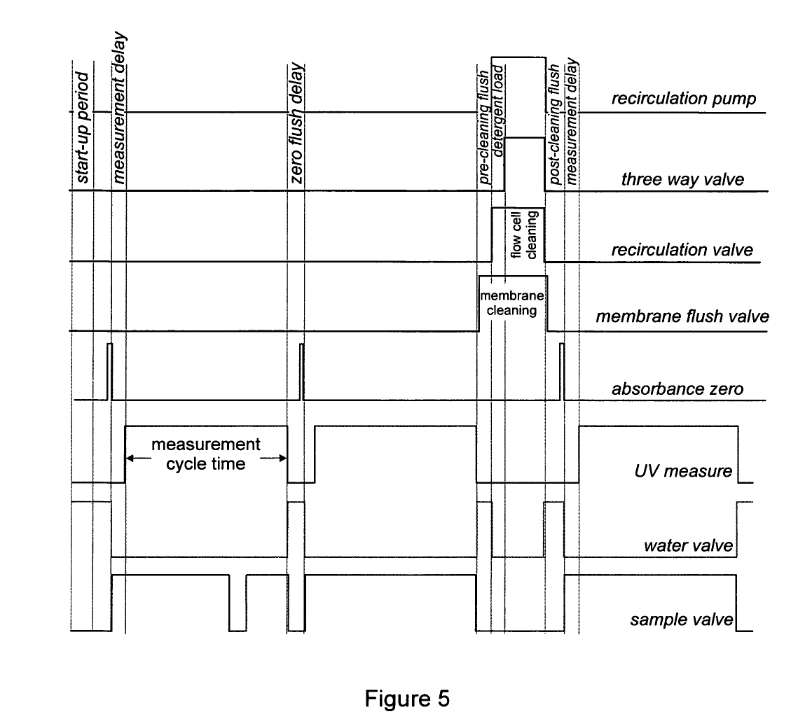

Referring now to FIG. 5 shown is a simplified timing diagram for different events for the measurement and referencing system with the components shown in FIG. 2. FIG. 5 refers to a membrane sampling system, which is not shown in FIG. 2, but which also optionally is washed at the same time as the flow cell. It is to be understood that time progresses from left to right along the horizontal-axis in FIG. 5, but that the timing diagram is not drawn to scale. Beginning at the left-hand side of FIG. 5, there is a start up period and a first instrumental zeroing event, during which the sample water valve 30 is closed and the reference water valve 32 is open. Next, the reference water valve 32 is closed and the sample water valve 30 is opened, and a delay occurs before the beginning of the UV measurement cycle time. The UV measurement cycle time is long compared to the instrumental zeroing event. At the end of the UV measurement cycle time, the reference water valve 32 is opened and the sample water valve 30 is closed. There is a zero flush delay, during which the purified reference water is passed through the system to flush out any sample water that remains. A second instrumental zeroing event then occurs. In FIG. 5, a second measurement cycle time is indicated before a cleaning cycle begins. However, depending upon the particular application, optionally additional alternating instrumental zeroing events and measurement cycles are performed prior to cleaning. During the cleaning cycle, the sample water valve 30 is closed and the system is flushed with purified reference water. Then the reference water valve 32 is also closed, the pump 64 is activated and detergent is loaded from the detergent source 62 as the second control valve 68 is opened. After the relatively short initial wash with detergent, the first control valve is switched to the position for diverting the detergent away from the drain 34 and along the path toward the pump 64. Next, the system is returned to the initial start-up condition, and purified reference water is used to flush detergent to the drain 34. The entire cycle then repeats, beginning with an instrumental zeroing event.

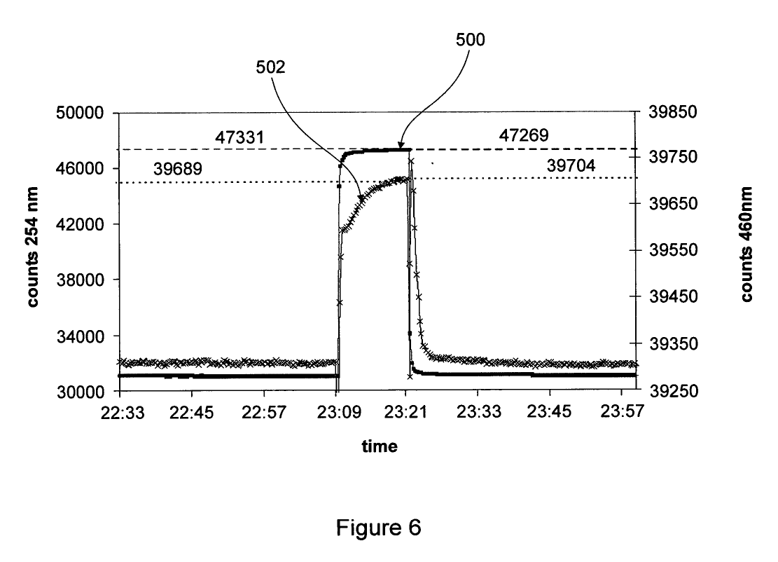

Referring now to FIG. 6, shown is a plot of experimental data obtained during an instrumental zeroing event for 254 nm (trace 500) and for 460 nm (trace 502). The counts along the ordinate are an arbitrary intensity (based on 16 bit digitization) of the light detected through a measurement cell, where a large count corresponds to low absorbance and a relatively smaller count corresponds to a relatively higher absorbance. The central “peak” corresponds to data points collected during the zeroing event. The change in the zero reference is 0.015% for the 460 nm measurement and 0.13% for the measurement at 254 nm, relative to the previous zero reference obtained at the same wavelength.

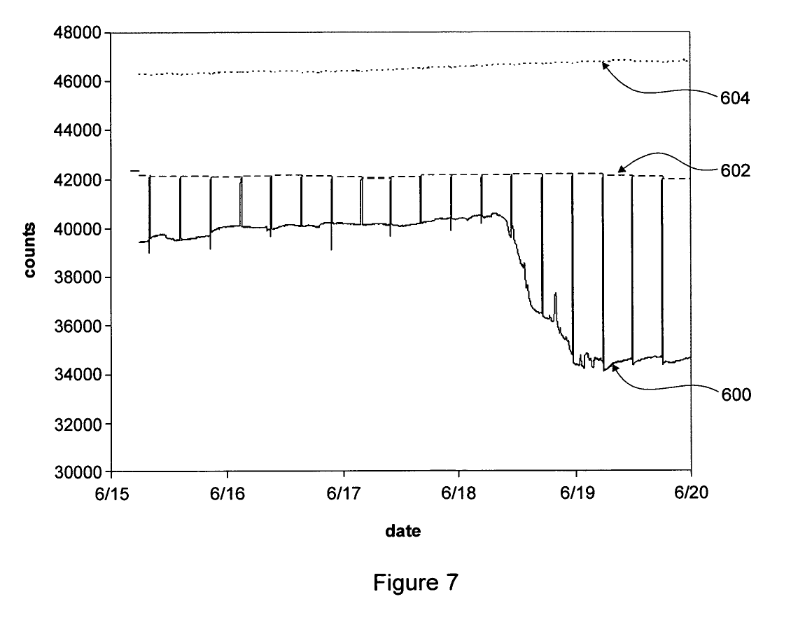

Referring now to FIG. 7, shown is a plot of experimental data obtained during five days of light intensity measurements at 460 nm, showing the measurement for sample water at 460 nm (lower trace 600), the reference light intensity at 460 nm (upper trace 604) as measured along the reference path 8 that does not include the flow-through cell 14, and the zero intensity at 460 nm (middle trace 602) measured with purified reference water in the flow-through cell 14. A period of unusually heavy rainfall, beginning around day four, caused increased levels of light absorbing species in the sample water. The instrument zero was done at each peak with a new zero taken in the last moments of the peak. The peaks are created by a cycle of purified reference water through the flow-through cell 14. FIG. 7 illustrates that over this five-day period of time, the zero measurement at 460 nm that was obtained using purified reference water is approximately constant. In contrast, changes in the reference light intensity at 460 nm are considered to be substantial over the same five-day period of time. During this particular five-day period of time, the reference light intensity increases, perhaps as a result of light source gas pressure or temperature changes.

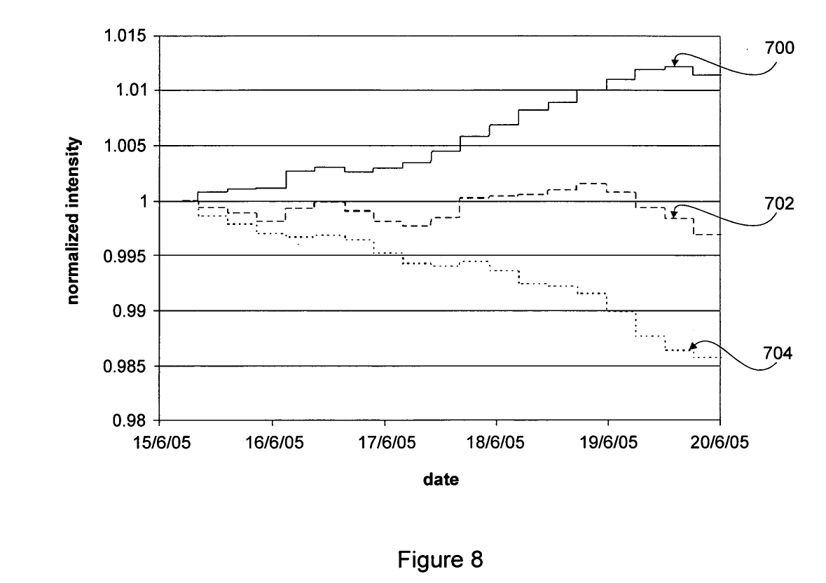

Referring now to FIG. 8, shown are relative values of reference light intensity as measured through the flow-through cell 14 during zeroing events versus the intensity as measured along the reference path 8 that does not include the flow-through cell 14. The values are normalized with respect to the starting time (t=0) so that all values appear to be one at the starting time. The increase in the lamp reference intensity indicates that the lamp intensity along an optical path that does not include the flow cell is generally increasing during this time period, as shown by trace 700. The relative intensity through the flow-through cell 14, as a result of the combination of changes related to lamp intensity and attenuation of the light due to cell fouling, is shown as trace 702. The ratio of these two values, relative intensity through the flow-through cell 14 divided by the relative intensity independent of the flow-through cell 14, is shown by trace 704. It is by the amount shown by trace 704 that the reference intensity is off when making the absorbance calculation of a water sample.

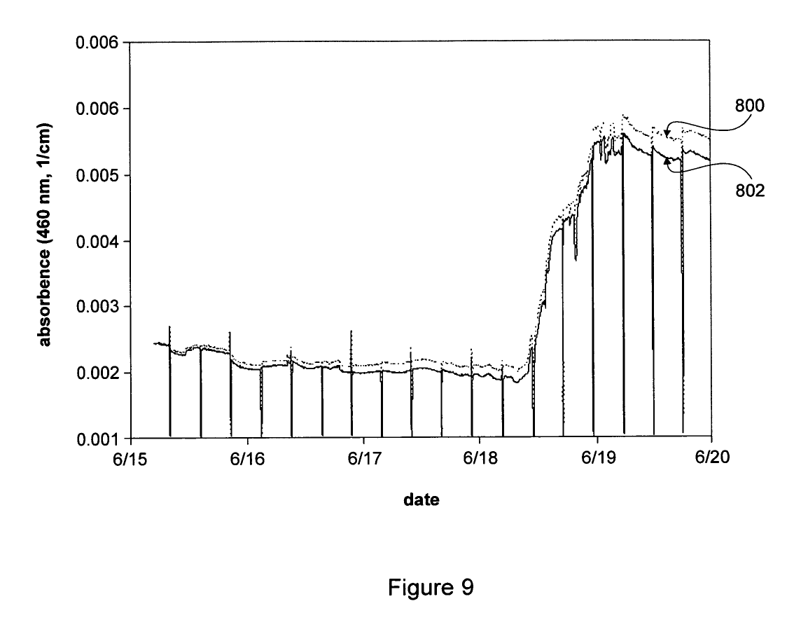

Referring now to FIG. 9, shown is a plot of experimental data obtained during five days of light intensity measurements at 460 nm, showing a comparison of absorbance values that were obtained after making a correction based upon the reference light intensity as measured along the reference optical path (trace 800), and after making a correction based upon the zero value as measured through the sample cell when filled with purified reference water (trace 802). In particular, the absorbance values along trace 800 were calculated according to equation 2, whereas the absorbance values along trace 802 were calculated according to equation 3. An instrumental zeroing event was performed using purified reference water, once approximately every six hours, during collection of data points along trace 802. Significantly, the absorbance values along trace 802 are consistently lower than the absorbance values along trace 800. This result is obtained because absorbance due to cell window fouling is automatically subtracted from the data points along trace 802, but not from the data points along trace 800. The result is that the absorbance values obtained using multiple zero reference corrections are relatively more accurate, compared to the absorbance values based upon a single instrumental zeroing event using purified reference water at start-up and with subsequent corrections based on reference illumination intensity.

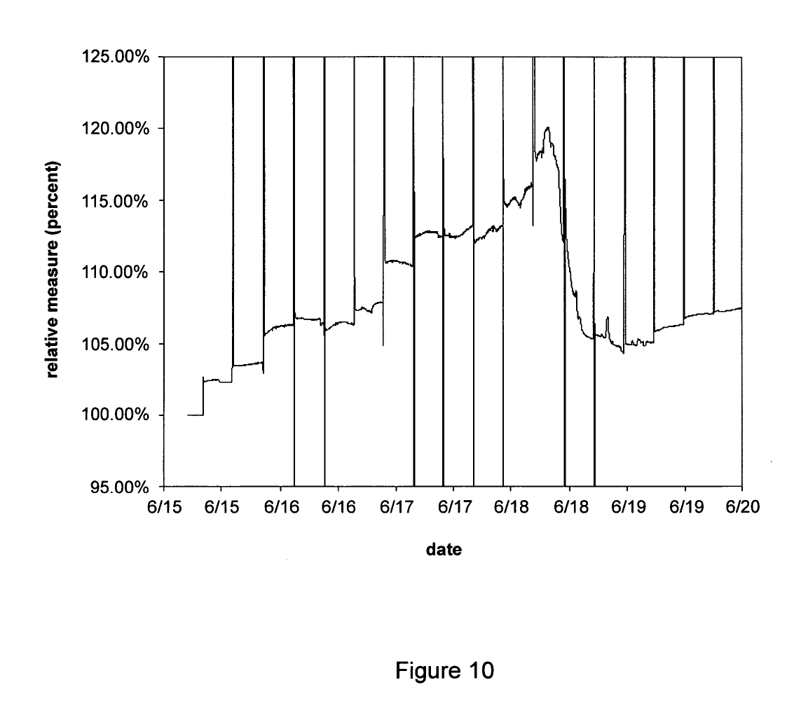

Referring now to FIG. 10, shown is a plot obtained by dividing the absorbance value as corrected using only the reference light intensity by the absorbance value as corrected by periodically re-zeroing the instrument when purified reference water is present in the flow-through cell 14. FIG. 10 shows that fouling that occurs on the flow-through cell windows slowly biases the measurement through the flow-through cell 14, unless the signal from that fouling is removed by re-zeroing the reference light intensity using an intensity of light obtained after passage through the flow-through cell 14 when filled with purified reference water.

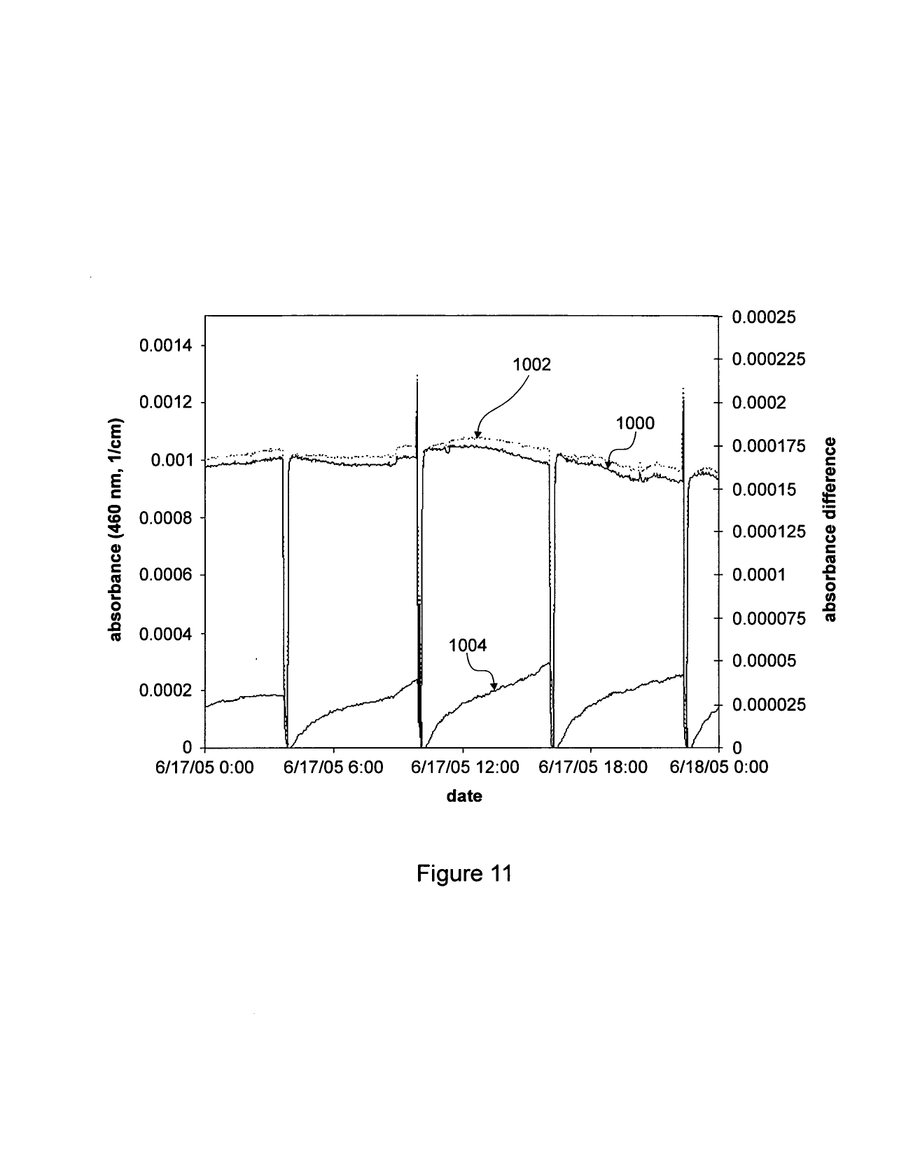

Referring now to FIG. 11, shown is a comparison of the absorbance values calculated according to equations 3 and 4 for a 24-hour period during the five days of light intensity measurements. In particular, the absorbance values along trace 1000 were calculated using equation 3 and the absorbance values along trace 1002 were calculated using equation 4. In both cases the absorbance values were corrected based upon the periodic instrumental zeroing events using purified reference water in the flow-through cell 14. The values along trace 1002 are adjusted for small changes in the light intensity using a corrective intensity obtained at detector 10. The small differences between these measurements are shown in the graph with the units on the right side of the graph. These differences are related to instrument drift that occurs due to changes in light intensity over the six hour period between instrument zeroing events.

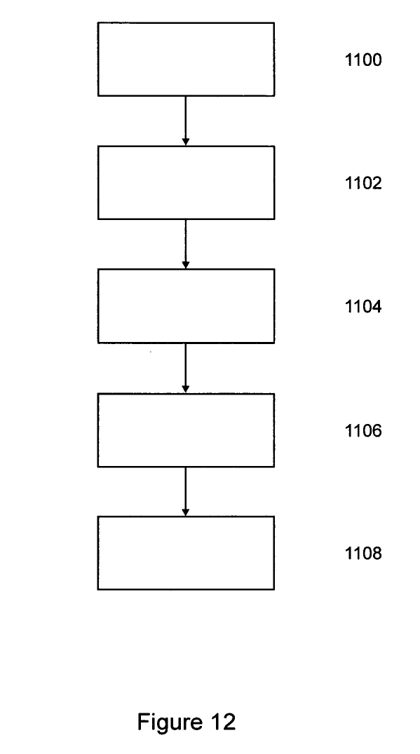

Referring now to FIG. 12, shown is a simplified flow diagram of a method for automatically zeroing a water quality analyzer system, according to an embodiment of the instant invention. At step 1100, an amount of purified reference water is produced using water that is provided from a reference water source along a first water flow path including a water purification unit. The water purification unit is co-located with the water quality analyzer system, such that the purified reference water is provided from the water purification unit to the water quality analyzer absent manual distribution. Preferably, the purified reference water is used in an instrumental zeroing event shortly after being produced by the water purification unit. For instance, the purified reference water is used within 6 hours of being produced. Optionally, the purified reference water is used at time intervals corresponding to the amount of time that is required to produce sufficient purified reference water for a single instrumental zeroing event. At step 1102 a flow-through sample cell of the water quality analyzer system is purged during a first period of time using a first portion of the amount of purified reference water. At step 1104 the flow-through sample cell is filled during a second period of time using a second portion of the amount of purified reference water. At step 1106 a first measurement is obtained using the water quality analyzer system when the flow-through sample cell is filled with the second portion of the amount of purified reference water. At step 1108, at least a value relating to the first measurement is used to correct a subsequent measurement obtained when sample water is provided to the flow-through sample cell via a second water flow path not including the water purification unit.

At least some of the above-mentioned embodiments of the instant invention provide significant advantages compared to other solutions that have been put forward. For instance, at least some of the above mentioned embodiments provide purified reference water from a water purification unit directly for use in an instrumental zeroing event. In this case, there is no reservoir of water to maintain and monitor. Since the purified reference water is generated on-site and on-demand, the problem of running out of purified reference water is obviated. In addition, there is no bulky reservoir of water to be stored on-site. Furthermore, the final purity of the reference water is selectable for different applications simply by adding or removing water purification elements from the system. For instance, in some geographic regions a heavy spring run-off requires additional adsorption units to remove agricultural contaminants that are dissolved in the water, but during the drier summer season the additional adsorption units are safely be removed since the reference water source is substantially cleaner.

It is another advantage of at least some of the above-mentioned embodiments of the instant invention that, since only a relatively small amount of reference water need be purified between zeroing events, highly effective but very low volume filter elements are suitable for use. Accordingly, the capital cost and ongoing maintenance cost of operating larger-scale water purification systems are avoided. Furthermore, since only relatively small volumes of water are being purified over time, the purification elements are expected to have a very long life span prior to needing to be replaced. Thus, optionally very expensive water purification elements are used to obtain very highly purified water, since the expected replacement frequency is very low. In fact, this advantage is even more significant when a small water storage reservoir is provided in communication with the water purification unit for accumulating purified reference water between zeroing events. In this way, water is purified continuously between zeroing events but at a very low flow rate, wherein the zeroing events are scheduled to coincide approximately with the filling of the water storage reservoir. Advantageously, since typically only 200 ml to 500 ml is required for a single zeroing event, the reservoir is sufficiently lightweight and compact to be mountable on a wall or other convenient surface.

Numerous other embodiments may be envisaged without departing from the spirit and scope of the invention.

What is claimed is:

1. A water supply sub-system for connection to a water quality analyzer unit, the water quality analyzer unit including a sample cell disposed along an optical path that is defined between a light source and a detector of the water quality analyzer unit, said water supply sub-system comprising:
a water purification unit comprising an inlet for connection to a source of reference water and for providing a flow of reference water along a fluid flow path through the water purification unit, a water purification element disposed along the fluid flow path for receiving the flow of reference water and for removing a contaminant species therefrom so as to produce a flow of purified reference water, and an outlet for providing the flow of purified reference water from the water purification unit, the water purification element comprising a reverse osmosis unit;
a reference water valve in fluid communication with the outlet and for being connected to the water quality analyzer unit, the reference water valve controllably switchable between an open position for providing the flow of purified reference water to the water quality analyzer unit during a first period of time and a closed position for preventing the flow of purified reference water to the water quality analyzer unit during a second period of time; and,
a sample water valve in fluid communication with a sample water source and for being connected to the water quality analyzer unit, the sample water valve controllably switchable between an open position for providing a flow of sample water to the water quality analyzer unit during the second period of time and a closed position for preventing the flow of sample water to the water quality analyzer unit during the first period of time.

2. A water supply sub-system according to claim 1, wherein the reference water valve and the sample water valve are automated valves.

3. A water supply sub-system according to claim 2, comprising a controller for providing control signals for controllably switching the automated reference water valve and the automated sample water valve in a synchronized fashion.

4. A water supply sub-system according to claim 1, wherein the water purification element comprises a plurality of different water purification element types.

5. A water supply sub-system according to claim 1, wherein the water purification element comprises at least one of an activated carbon block filter and an activated carbon granular filter.

6. A water supply sub-system according to claim 1, comprising a bubble trap disposed between the water purification element and the reference water valve.

7. A water supply sub-system according to claim 1, comprising a water storage unit in fluid communication with the outlet and with the reference water valve, the water storage unit for receiving a flow of purified water from the outlet and for temporarily storing a known volume of the purified water.

8. A water supply sub-system according to claim 1, wherein the reference water valve comprises a solenoid valve.

9. A method for automatically zeroing a water quality analyzer system, comprising:
producing an amount of purified reference water by providing water from a reference water source along a first water flow path through a water purification unit, the water purification unit co-located with the water quality analyzer system and comprising a reverse osmosis unit;
during a first period of time, purging a flow-through sample cell of the water quality analyzer system with a first portion of the amount of purified reference water;
during a second period of time, filling the flow-through sample cell with a second portion of the amount of purified reference water;
obtaining a first measurement using the water quality analyzer system when the flow-through sample cell is filled with the second portion of the amount of purified reference water; and,
using at least a value relating to the first measurement to correct a subsequent measurement obtained when sample water is provided to the flow-through sample cell via a second water flow path not including the water purification unit.

10. A method according to claim 9, wherein the purified reference water is produced absent manual distribution of the purified reference water.

11. A method according to claim 9, wherein the first measurement is a measure of one of light absorbance, light attenuation and light transmittance when the flow-through sample cell is filled with the second portion of the amount of purified reference water.

12. A method according to claim 9, comprising purging the flow-through sample cell with sample water prior to obtaining the subsequent measurement.

13. A method according to claim 9, comprising circulating a cleaning agent through the flow-through sample cell prior to filling the flow-through sample cell with the second portion of the amount of purified reference water.

14. A method according to claim 9, wherein purging the flow-through sample cell of the water quality analyzer system with a first portion of the amount of purified reference water comprises:
actuating an automated sample water valve between an open position and a closed position for stopping a flow of sample water to the flow-through sample cell; and,
actuating an automated reference water valve between a closed position and an open position, for providing purified reference water from the first water flow path to a second water flow path including the flow-through sample cell.

15. A method according to claim 14, comprising providing a first control signal from a controller to the automated sample water valve for actuating the automated sample water valve between the open position and the closed position, and providing a second control signal from the controller to the automated reference water valve for actuating the automated reference water valve between the closed position and the open position.

16. A method according to claim 15, wherein the first control signal and the second control signal are provided at predetermined time intervals.

17. A method according to claim 16, wherein the predetermined time intervals are shorter than 6 hours.

18. A method according to claim 9, wherein providing water from a reference water source along a first water flow path including a water purification unit comprises flowing the water through a plurality of different water purification element types.

19. A method according to claim 9, wherein providing water from a reference water source along a first water flow path including a water purification unit comprises flowing the water through the reverse osmosis unit and at least one of an activated carbon block filter and an activated carbon granular filter.

20. A method according to claim 19, comprising flowing the water through a bubble trap.

21. A method according to claim 9, wherein providing water from a reference water source along a first water flow path including a water purification unit comprises flowing the water through a bubble trap.

22. A method according to claim 9, wherein the first measurement and the subsequent measurement are each a measurement of one of an attenuation, an absorbance and a transmittance of light at a single wavelength.

23. A method according to claim 9, wherein the first measurement and the subsequent measurement are each a measurement of one of an attenuation, an absorbance and a transmittance of light at each of a plurality of different single wavelengths.

24. A method according to claim 9, wherein obtaining a first measurement comprises launching light at a wavelength within the ultraviolet region of the electromagnetic spectrum along an optical path through the second portion of the amount of purified reference water within the flow-through sample cell.

25. A method according to claim 9, wherein obtaining a first measurement comprises launching light at a wavelength within the infrared region of the electromagnetic spectrum along an optical path through the second portion of the amount of purified reference water within the flow-through sample cell.

26. A method according to claim 9, wherein obtaining a first measurement comprises launching light at a wavelength within the visible region of the electromagnetic spectrum along an optical path through the second portion of the amount of purified reference water within the flow-through sample cell.

27. A water quality analyzer system, comprising:
a flow-through sample cell having a first inlet for receiving a flow of water, a containing portion for containing temporarily a known amount of the flow of water, and a first outlet;
a light source for launching light at a wavelength within a predetermined region of the electromagnetic spectrum along an optical path through the flow-through sample cell;
a light-detector disposed for receiving the light at a wavelength within a predetermined region of the electromagnetic spectrum after transmission through the flow-through sample cell;
a water purification unit comprising a second inlet, a second outlet and a water purification element that is disposed along a water flow path between the second inlet and the second outlet, the second inlet for connection to a reference water source for providing a flow of water from the reference water source along the water flow path through the water purification element and out the second outlet, the water purification element comprising a reverse osmosis unit;
an automated reference water valve in fluid communication with the second outlet, the reference water valve actuatable between an open position for providing a flow of purified water to the containing portion of the flow-through sample cell via the first inlet during a first period of time, and a closed position for preventing a flow of purified water to the containing portion of the flow-through sample cell during a second period of time; and,
a sample water valve in fluid communication with a sample water source, the sample water valve controllably switchable between an open position for providing a flow of sample water to the containing portion of the flow-through sample cell via the first inlet during the second period of time and a closed position for preventing the flow of sample water to the containing portion of the flow-through sample cell during the first period of time.

28. A water quality analyzer system according to claim 27, wherein the light source is an ultraviolet light source.

29. A water quality analyzer system according to claim 27, wherein the light source is an infrared light source.

30. A water quality analyzer system according to claim 27, wherein the light source is a visible light source.
